(19) United States
(12) Patent Application Publication
(10) Pub. No.: US 2010/0018360 A1
(43) Pub. Date: Jan. 28, 2010

(54) ASSEMBLY ELEMENT FOR A HAND TOOL

(76) Inventor: Jun-Tsai Shyu, Taichung (TW)

Correspondence Address: Jun-Tsai Shyu, 13F, No. 23, Jiun-Ho Street, Beitun District, Taichung, 406, omitted

(21) Appl. No.: 12/181,312

(22) Filed: Jul. 28, 2008

(51) Int. Cl. B25B 13/58

(52) U.S. Cl. 81/180.1

(57) ABSTRACT

An assembly element for a hand tool including accessories of force-applying hand tools such as a socket, a connecting bar, a universal adapter, etc. A rubber ring groove is formed at a certain position of an external portion having a maximal circumference. A rubber ring with a polygonal anti-rolling portion fits into the rubber ring groove for protecting from an unexpected rolling action. Meanwhile, the rubber ring has different colors for an easy identification of the item number, size, type, etc.

### BACKGROUND OF THE INVENTION

1. Fields of the Invention

The invention relates to an assembly element for a hand tool, and more particularly, to a structure for avoiding an undesired rolling. Moreover, it serves as an identification label for an easy identification of the item number, size, type, etc.

2. Description of the Related Art

The assembly element for a hand tool includes accessories of force-applying hand tools (screwdrivers, wrenches, ratchets, etc.) such as a socket, a connecting bar, a universal adapter, etc. By connecting both of them to each other, the screws can be tightened. In considering an easy and economical production, all of the existing assembly elements include a smooth cylindrical body at the largest part thereof. That is, the part held by the operator is formed as a smooth cylindrical body. According to the existing application, the assembly element is placed in a horizontal position since it is formed in a cylindrical shape. Therefore, an undesired rolling movement takes place. Thus, the operator has to pay attention to its position at all time. Even, he must be distracted to find it. This would cause much inconvenience and delay of work.

As shown in FIG. 10, a socket 10 has a peripheral portion 12 in a polygonal shape for improving the above-mentioned drawbacks. This construction may achieve the expected effect. However, the production of the peripheral portion 12 is not economical. The production thereof is done in such a manner that a metal piece with a larger diameter is trimmed and then exposed to a heat and galvanic treatment. The production thereof does not meet the economical and efficient requirements since the material cost and the processing cost considerably rise. Moreover, an unnecessary waste of metal material is caused.

### SUMMARY OF THE INVENTION

In view of the shortcomings of the prior art, the inventor of the present invention, based on years of experience in the related industry to conduct extensive researches and experiments, finally developed an assembly element for a hand tool in which a rubber ring with a polygonal anti-rolling portion is mounted at a certain position of an external portion having a maximal circumference thereof, thereby eliminating all of the drawbacks in operation and production of the conventional products and the prior structures. Meanwhile, the rubber ring has different colors for an easy identification of the item number, size, type, etc. This is the primary object of the invention.

According to the invention, a rubber ring groove is formed at a certain position of an external portion having a maximal circumference of the assembly element. A rubber ring with a polygonal anti-rolling portion fits into the rubber ring groove for protecting from an unexpected rolling action. Meanwhile, the rubber ring has different colors for an easy identification of the item number, size, type, etc.

### BRIEF DESCRIPTION OF THE DRAWINGS

The accomplishment of this and other objects of the invention will become apparent from the following description and its accompanying drawings of which:

FIG. 1 is an exploded perspective view of a first embodiment of the invention;

FIG. 2 is a perspective assembly view of the embodiment according to FIG. 1;

FIG. 3 is a schematic drawing of the embodiment according to FIG. 1;

FIG. 4 is a schematic drawing of the embodiment according to FIG. 1 seen from another side;

FIG. 5 is a simplified drawing of another embodiment of a rubber ring groove in accordance with the invention;

FIG. 6 is a simplified drawing of a further embodiment of a rubber ring groove in accordance with the invention;

FIG. 7 is a perspective view of a second embodiment of the invention;

FIG. 8 is a perspective view of a third embodiment of the invention;

FIG. 9 is a perspective view of a fourth embodiment of the invention; and

FIG. 10 is a perspective view of a conventional construction.

### DETAILED DESCRIPTION OF THE PREFERRED EMBODIMENT

The present invention will now be described in more detail hereinafter with reference to the accompanying drawings that show various embodiments of the invention.

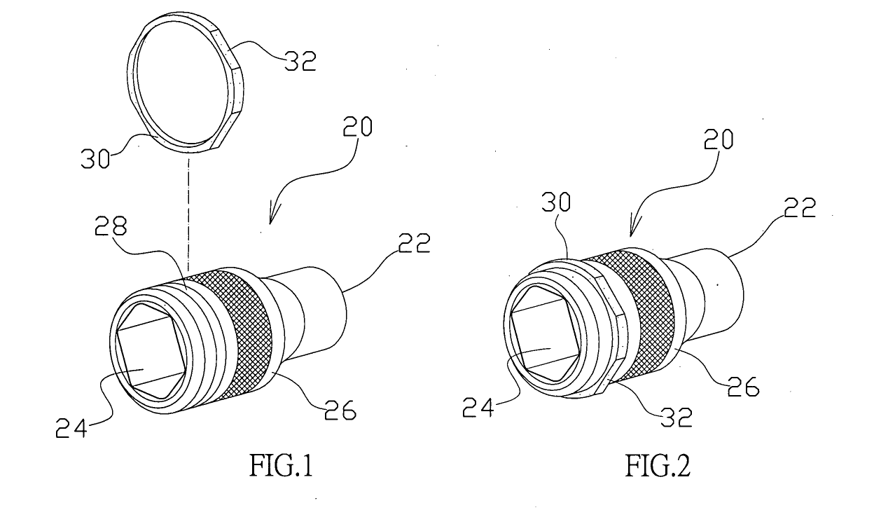

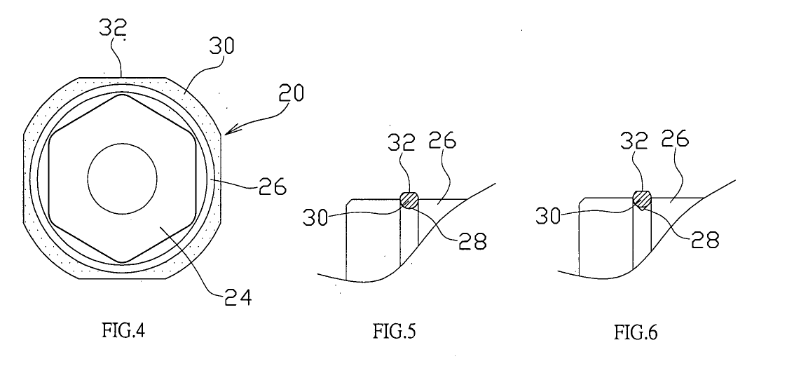

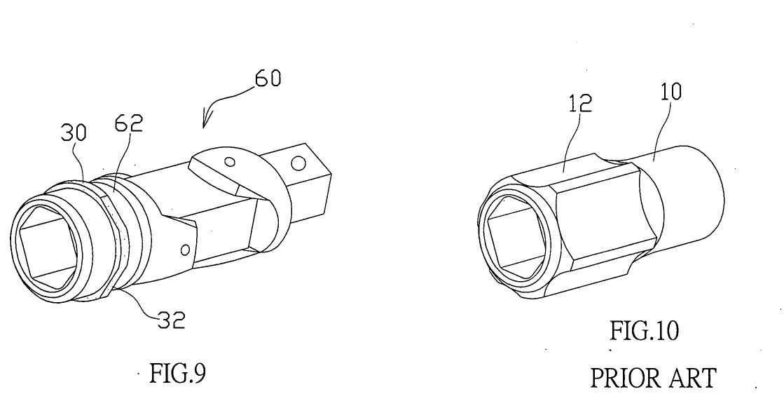

Referring to FIGS. 1 through 4, an assembly element in accordance with a preferred embodiment of the invention includes a socket 20 having a tool insertion hole 22 at one end thereof and a slot 24 at the other end thereof. A rubber ring groove 28 is formed at a certain position of an external portion 26 having a maximal circumference. A rubber ring 30 with a polygonal anti-rolling portion 32 fits into the rubber ring groove 28 for protecting from an unexpected rolling action. Meanwhile, the rubber ring 30 has different colors for an easy identification of the item number, size, type, etc.

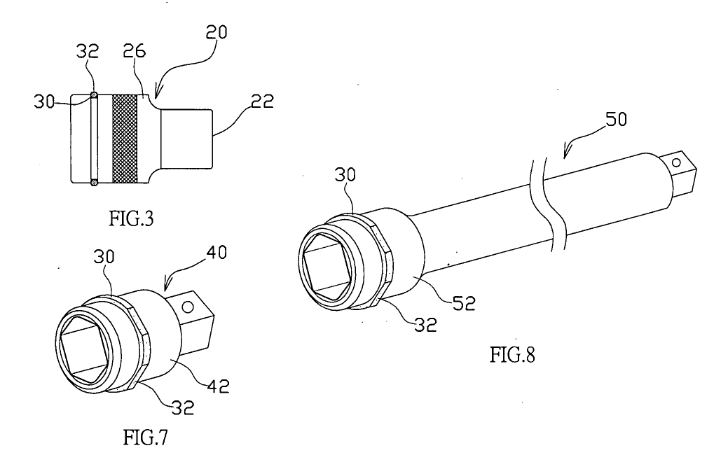

As shown in FIGS. 3, 5, and 6, the rubber ring groove 28 can be formed in geometric shape such as in a shape of square, arch or pointed cone for a tight mounting of the rubber ring 30, Likewise, the number of the anti-rolling portion 32 of the rubber ring 30 can vary according to different use requirements.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An assembly element for a hand tool including accessories of force-applying hand tools such as a socket, a connecting bar, a universal adapter, etc., wherein a rubber ring groove is formed at a certain position of an external portion having a maximal circumference, and a rubber ring with a polygonal anti-rolling portion fits into the rubber ring groove.

2. The assembly element as recited in claim 1, wherein the rubber ring has different colors.
